(19) United States
(12) Patent Application Publication
(10) Pub. No.: US 2025/0193088 A1
(43) Pub. Date: Jun. 12, 2025

(54) METHOD AND APPARATUS FOR CONFIGURING ARTIFICIAL INTELLIGENCE AND MACHINE LEARNING TRAFFIC TRANSPORT IN WIRELESS COMMUNICATIONS NETWORK

(71) Applicant: SAMSUNG ELECTRONICS CO., LTD., Suwon-si, Gyeonggi-do (KR)

(72) Inventor: Mehrdad SHARIAT, Staines, Middlesex (GB)

(21) Appl. No.: 18/844,886

(22) PCT Filed: Mar. 29, 2023
(86) PCT No.: PCT/KR2023/004154

§ 371 Date: Sep. 6, 2024

(30) Foreign Application Priority Data
Mar. 29, 2022 (GB) 2204488.7
Mar. 7, 2023 (GB) 2303322.8

(51) Int. Cl. H04L 41/16; H04L 41/0894; H04W 8/24

(52) U.S. Cl. CPC H04L 41/16; H04L 41/0894; H04W 8/24

(57) ABSTRACT

The disclosure relates to a 5G or 6G communication system for supporting a higher data transmission rate. A method for configuring artificial intelligence/machine learning (AI/ML) traffic transport in a wireless communications network is disclosed. The method comprising receiving, by a policy control function (PCF), from a unified data repository (UDR), a notification of an update of AI/ML transport configuration information; determining, by the PCF, whether an AI/ML protocol data unit (PDU) session or a transport policy are impacted by the update; and notifying by the PCF, a session management function (SMF) that a SM policy is updated, wherein the SMF is configured to reconfigure the PDU session based on the updated SM policy.

### TECHNICAL FIELD

Certain examples of the present disclosure provide techniques relating to configure artificial intelligence (AI) and/or machine leaning (ML) traffic transport.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

AI/ML is being used in a range of application domains across industry sectors. In mobile communications systems, conventional algorithms (e.g. speech recognition, image recognition, video processing) in mobile devices (e.g. smartphones, automotive, robots) are being increasingly replaced with AI/ML models to enable various applications.

The above information is presented as background information only to assist with an understanding of the present disclosure. No determination has been made, and no assertion is made, as to whether any of the above might be applicable as prior art with regard to the present invention.

### DISCLOSURE OF INVENTION

### Technical Problem

Certain examples of the present disclosure provide methods, apparatus and systems for configuring AI and/or ML traffic transport in a 3rd generation partnership project (3GPP) 5th generation (5G) network.

### Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

In accordance with an embodiment of the present disclosure, a method and an apparatus for configuring artificial intelligence/machine learning (AI/ML) traffic transport in wireless communications network.

In according with an embodiment of the present disclosure, a method and an apparatus for communicating AI/ML transport configuration information in a wireless communications network.

In accordance with an embodiment of the present disclosure, a method for configuring artificial intelligence/machine learning (AI/ML) traffic transport in a wireless communications network is provided. The method comprises receiving, by a policy control function (PCF), from a unified data repository (UDR) that stores AI/ML transport configuration information, a notification of un update of the AI/ML configuration information, determining, by the PCF, whether an AI/ML protocol data unit (PDU) session or a transport policy is impacted by the update, and based on determining that the AI/ML session or the transport policy being impacted by the update, notifying by the PCF, a session management function (SMF) that a session management (SM) policy is updated. The SMF may be configured to reconfigure the PDU session transporting AI/ML traffic based on the updated SM policy.

In an example, the method further comprises sending, by the SMF, to an access and mobility management function (AMF), information on the reconfigured PDU session.

In an example, the method further comprises updating, by the SMF, a user equipment (UE) based on the AI/ML transport configuration information.

In an example, the updating the UE based on the AI/ML transport configuration information comprises updating one or more of an AI/ML application function (AF) address, an AI/ML domain name system (DNS) server address, an AI/ML traffic type, or AI/ML authentication information.

In an example, the method further comprises indicating, by the UE, a capability for receiving the AI/ML transport configuration information during a PDU session establishment or PDU session modification procedure.

In an example, the AI/ML transport configuration information is received by the UDR as part of an AI/ML application function (AF) request.

In an example, the AI/ML AF request is received directly from an AI/ML AF or via a network exposure function (NEF).

In an example, the AI/ML AF request is part of a PDU session establishment procedure or a PDU session modification procedure for updating the AI/ML transport configuration information or associated validity parameters.

In an example, the AI/ML AF request further includes a traffic description, the traffic description including one or more of a data network name (DNN), a single network slice selection assistance Information (S-NSSAI), an application identifier, an application ID, or traffic filtering information.

In an example, the AI/ML AF request further includes one or more of potential location information of AI/ML applications, target UE identifiers, spatial validity information, time validity information, user plane latency requirements, quality of experience requirements, or indications associated with a AI/ML traffic type.

In an example, the PDU session transports AI/ML traffic, and reconfiguring the PDU session includes reconfiguring a user plane of the PDU session.

In an example, the reconfiguring a user plane of the PDU session includes one or more of allocating a new prefix to a UE, updating a user plane function (UPF) with new traffic steering rules, or determining whether to relocate the UPF.

In an example, the AI/ML transport configuration information is received by the UDR from an AI/ML application function (AF) or a network exposure function (NEF).

In an example, the AI/ML transport configuration information is pre-configured by the AI/ML service provider on the AI/ML AF and/or an AI/ML application client on the UE.

In an example, the AI/ML transport configuration information includes one or more of an AI/ML application function (AF) address, an AI/ML domain name system (DNS) server address, an AI/ML traffic type, or AI/ML authentication information.

In an example, the AI/ML transport configuration information is determined by a service level agreement (SLA) between a mobile network operator (MNO) and an AI/ML application service provider associated with the AI/ML AF.

In an example, the AI/ML transport configuration information is per AI/ML application ID.

In accordance with an embodiment of the present disclosure, a policy control function (PCF) for configuring artificial intelligence/machine learning (AI/ML) traffic transport in a wireless communications network is disclosed. The PCF may comprises a transceiver and a processor coupled with the transceiver and configured to control the transceiver to receive, from a unified data repository (UDR) that stores AI/ML transport configuration information, a notification of an update of the AI/ML transport configuration information, determine whether an AI/ML protocol data unit (PDU) session or a transport policy is impacted by the update, and based on determining that the AI/ML PDU session or the transport policy being impacted by the update, notify a session management function (SMF) that updated session management (SM) policy is updated. The SMF may be configured to reconfigure the PDU session transporting AI/ML traffic based on the updated SM policy.

In accordance with an embodiment of the present disclosure, a wireless communications network comprising a plurality of network entities including a unified data repository (UDR), a policy Control function (PCF), and a session management function (SMF) is provided. The UDR may be configured to receive AI/ML transport configuration information, update AI/ML transport configuration information based on the received AI/ML configuration information, and notify a policy control function (PCF) of the update of the AI/ML configuration information. The PCF may be configured to receive, from the UDR, a notification of the update of the AI/ML configuration information and determine whether an AI/ML protocol data unit (PDU) session or a transport policy is impacted by the update, and based on determining that the AI/ML PDU session or the transport policy being impacted by the update, notify a session management function (SMF) that a session management (SM) policy is updated. The SMF may be configured to reconfigure the PDU session transporting AI/ML traffic based on the updated SM policy;

In an example, the wireless communications network further comprises an access and mobility management function (AMF), wherein the SMF is configured to send, to the AMF, information on the reconfigured PDU session.

In an example, the wireless communications network further comprises comprising a user equipment (UE), wherein the SMF is configured to update the UE based on the AI/ML transport configuration information.

In an example, the wireless communications network is a 3GPP 5G network.

Embodiments or examples disclosed in the description and/or figures falling outside the scope of the claims are to be understood as examples useful for understanding the present invention.

Other aspects, advantages and salient features of the invention will become apparent to those skilled in the art from the following detailed description taken in conjunction with the accompanying drawings.

### BRIEF DESCRIPTION OF DRAWINGS

This disclosure is illustrated in the accompanying drawings, throughout which like reference letters indicate corresponding parts in the various figures. The embodiments herein will be better understood from the following description with reference to the drawings, in which:

FIG. 1 is an example architecture for AI/ML transport model;

FIG. 2 is an example call flow diagram illustrating AI/ML AF influence over traffic routing and/or reconfiguration for AI/ML traffic; and

FIG. 3 is a block diagram of an exemplary network entity that may be used in certain examples of the present disclosure.

### MODE FOR THE INVENTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

Certain examples of the present disclosure provide techniques relating to artificial intelligence (AI) and/or machine leaning (ML) traffic transport. For example, certain examples of the present disclosure provide methods, apparatus and systems for AI and/or ML traffic transport in a 3rd Generation Partnership Project (3GPP) 5th Generation (5G) network. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G.

The following examples are applicable to, and use terminology associated with, 3GPP 5G. However, the skilled person will appreciate that the techniques disclosed herein are not limited to 3GPP 5G. For example, the functionality of the various network entities and other features disclosed herein may be applied to corresponding or equivalent entities or features in other communication systems or standards. Corresponding or equivalent entities or features may be regarded as entities or features that perform the same or similar role, function or purpose within the network.

The skilled person will also appreciate that the transmission of information between network entities is not limited to the specific form, type or order of messages described in relation to the examples disclosed herein.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 5G;
One or more entities in the examples disclosed herein may be replaced with one or more alternative entities performing equivalent or corresponding functions, processes or operations;
One or more of the messages in the examples disclosed herein may be replaced with one or more alternative messages, signals or other type of information carriers that communicate equivalent or corresponding information;
One or more further entities and/or messages may be added to the examples disclosed herein;
One or more non-essential entities and/or messages may be omitted in certain examples;
The functions, processes or operations of a particular entity in one example may be divided between two or more separate entities in an alternative example;
The functions, processes or operations of two or more separate entities in one example may be performed by a single entity in an alternative example;
Information carried by a particular message in one example may be carried by two or more separate messages in an alternative example;
Information carried by two or more separate messages in one example may be carried by a single message in an alternative example; and/or
The order in which operations are performed and/or the order in which messages are transmitted may be modified, if possible, in alternative examples.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

In the present disclosure, a UE may refer to one or both of Mobile Termination (MT) and Terminal Equipment (TE). MT may offer common mobile network functions, for example one or more of radio transmission and handover, speech encoding and decoding, error detection and correction, signalling and access to a SIM. An IMEI (international mobile equipment identity) code, or any other suitable type of identity, may attached to the MT. TE may offer any suitable services to the user via MT functions. However, it may not contain any network functions itself.

Herein, the following documents are referenced:
[1] 3GPP TS 22.261 V18.5.0
[2] 3GPP TS 23.501 V17.3.0
[3] 3GPP TS 23.502 V17.3.0

The 5G system can support various types of AI/ML operations, in including the following three defined in [1]:
AI/ML operation splitting between AI/ML endpoints;
AI/ML model/data distribution and sharing over 5G system; and/or
Distributed/Federated Learning over 5G system.

The AI/ML operation/model may be split into multiple parts, for example according to the current task and environment. The intention is to offload the computation-intensive, energy-intensive parts to network endpoints, and to leave the privacy-sensitive and delay-sensitive parts at the end device. The device executes the operation/model up to a specific part/layer and then sends the intermediate data to the network endpoint. The network endpoint executes the remaining parts/layers and feeds the inference results back to the device.

Multi-functional mobile terminals may need to switch an AI/ML model, for example in response to task and environment variations. An assumption of adaptive model selection is that the models to be selected are available for the mobile device. However, since AI/ML models are becoming increasingly diverse, and with the limited storage resource in a UE, not all candidate AI/ML models may be pre-loaded on-board. Online model distribution (i.e. new model downloading) may be needed, in which an AI/ML model can be distributed from a Network (NW) endpoint to the devices when they need it to adapt to the changed AI/ML tasks and environments. For this purpose, the model performance at the UE may need to be monitored constantly.

A cloud server may train a global model by aggregating local models partially-trained by each of a number of end devices (e.g. UEs). Within each training iteration, a UE performs the training based on a model downloaded from the AI server using local training data. Then the UE reports the interim training results to the cloud server, for example via 5G UL channels. The server aggregates the interim training results from the UEs and updates the global model. The updated global model is then distributed back to the UEs and the UEs can perform the training for the next iteration.

Different levels of interactions are expected between UE and AF as AI/ML endpoints, for example based on [1], to exchange AI/ML models, intermediate data, local training data, inference results and/or model performance as application AI/ML traffic.

However support for the transmission of Application AI/ML traffic, for example over 5GS, between AI/ML endpoints (e.g. UE and AF) as described above is not currently defined in the existing 5GC data transfer/traffic routing mechanisms.

What is desired are procedures and signalling defining how an AI/ML AF may influence the AI/ML data transfer and or traffic routing, for example over 5GS.

AI/ML Application may be part of TE using the services offered by MT in order to support AI/ML operation, whereas AI/ML Application Client may be part of MT. Alternatively, part of AI/ML Application client may be in TE and a part of AI/ML application client may be in MT.

The procedures disclosed herein may refer to various network functions/entities. The functions and definitions of certain network functions/entities, for example those indicated below, are known to the skilled person, and are defined, for example, in at least [2] and [3]:
application function (AF);
network exposure function (NEF);
unified data repository (UDR);
policy control function (PCF);
session management function (SMF);
user plane function (UPF);
access and mobility management function (AMF);
user equipment (UE); and/or
network repository function (NRF)

However, as noted above, the skilled person will appreciate that the present disclosure is not limited to the definitions given in [2] and [3], and that equivalent functions/entities may be used.

### Architecture

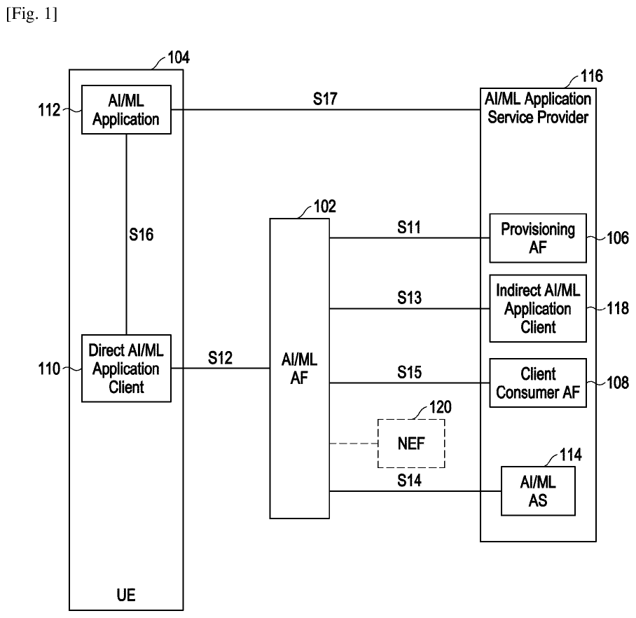

FIG. 1 shows a representation of an architecture according to an exemplary embodiment of the present disclosure.

As shown in FIG. 1, various entities are connected via a number of interfaces or reference points S11-S17. However, the skilled person will appreciate that the present disclosure is not limited to the example illustrated in FIG. 1. For example, in alternative examples, more or fewer interfaces may be provided, and/or interfaces between different entities may be provided. In addition, the interfaces may be referred to using any suitable terminology.

In the example of FIG. 1, reference points S11 and S15 govern interactions between different logical functions expected from an Application Function (AF). These may be realized, for example, centrally together or in a distributed manner as part of separate network entities.

The AI/ML AF 102 may be the network side end point for AI/ML operation that may be in charge of AI/ML operations, for example to split the model training, to distribute the model to the UE 104 or to collect and aggregate the local models, inference feedback, etc. from multiple UEs, for example in the case of federated learning. The latter role may be similar to a Data Collection Application Function (DCAF). Unlike DCAF, the processed model or data may not be only exposed to the Network Data Analytics Function (NWDAF) but also may be consumed by other 5GC NFs (e.g. via the provisioning AF as described below) or by other consumer AFs (as described below). Furthermore, AI/ML AF 102 may play other roles, e.g. provide assistance in UPF (re) selection in coordination with AI/ML application servers and/or in provisioning of transport configuration information and/or assistance in generating AI/ML UE policy or route selection policy (URSP) policies for the UE by the PCF (as described below).

The provisioning AF 106 may be in charge of provisioning external parameters and models (e.g. collected via S11 reference point) and/or exposing corresponding events, for example defined per AI/ML operation to the 5GC NFs over service based interface.

The consumer AF 108 (e.g., a client consumer AF) may represent an AF logic that may act as an external consumer of AI/ML AF models and/or AI/ML operations, for example over S15 reference point.

The AF (AI/ML AF 102, provisioning AF 106 or consumer AF 108) (e.g. when in trusted domain) may register in Network Repository Function (NRF) including, for example, DNN, S-NSSAI, supported Application ID(s), supported Event ID(s) and any relevant Group ID(s). The AF can be discovered by other 5GC NFs via NRF services.

Reference points S12, S13, S16 and S17 may govern how AI/ML traffic types are collected or distributed between the UE 104 and the network. For example, S16 interface may be used to collect local training models, inference results and/or model performance from AI/ML application to the direct AI/ML Application Client 110 on the UE 104. It may also be used to distribute (global) AI/ML model via direct AI/ML Application Client 110 to the AI/ML Application 112 on the UE 104.

S12 reference point may be used, for example, for the case of direct reporting between the UE 104 and network. In certain example, S12 may be realized over a user plane PDU session established between the UE and an anchor User Plane Function (UPF) within 5GC user plane. In the case of direct reporting between UE and the network over S12, the AI/ML AF 102 may also assist in UPF (re) selection in coordination with one or more AI/ML application servers (AI/ML AS) 114 over S14 reference point.

For the case of indirect reporting between UE and the network (e.g. using the indirect AI/ML application client 118), a combination of S17 and S13 may be used. In certain examples, S17 may be realized outside 3GPP domain.

In various examples, including one or more or all of the cases described above, when an interaction is expected between an untrusted entity outside 3GPP and a trusted entity within 3GPP domain, NEF 120 exposure services may be utilised.

### Transport Configuration Information

Various examples of AI/ML transport configuration information may be used in examples of the present disclosure. For example, transport configuration information may include one or more of address information, traffic type information, auxiliary data or metadata, authentication or security information, and other configuration information. A number of non-limiting examples will now described.

For both an AI/ML AF in trusted domain and an AI/ML AF in untrusted domain, a Service Level Agreement (SLA) between the mobile network operator (MNO) and the AI/ML application service provider (e.g. an ASP) 116 may determine the AI/ML transport configuration information (e.g. per AI/ML Application ID) with any combinations of one or more of:
AI/ML AF address;
AI/ML DNS server address;
AI/ML traffic type(s);
AI/ML metadata information;
Authentication information; and/or
Mode of reporting.

For AI/ML AF address, any suitable type of address may be used. For example, the AI/ML AF address may be fully qualified domain name(s) (FQDN(s)) and/or IP address(es) and or non-IP address(es) that the UE or the AI/ML application client on the UE can communicate to the AI/ML AF or any associated AI/ML applications server(s).

For AI/ML DNS server address, any suitable type of address may be used. The AI/ML DNS server address may be optionally used by the UE or the AI/ML Application client on the UE to resolve the AI/ML AF address from a FQDN to the IP address of the AI/ML AF or any associated AI/ML application server(s).

AI/ML traffic type(s) may indicate traffic type(s) that the UE and/or the AI/ML Application client on the UE can support, for example when interacting with the AI/ML AF or any associated AI/ML applications server(s), or vice versa (e.g. subject to user consent). Non-limiting examples of traffic type include any combination of one or more of AI/ML model, intermediate data, local training data, inference results, and model performance as application AI/ML traffic(s). In certain examples, a unified AI/ML traffic type may be adopted for all traffics between the UE (or the AI/ML Application client on the UE) and the AI/ML AF (or any associated AI/ML applications servers).

For AI/ML Metadata Information, any suitable type of metadata may be used, for example possible AI/ML processing algorithms and associated parameters supported by the AI/ML AF or any associated AI/ML applications server(s), for example for anonymisation, aggregation, normalisation, federated learning, etc.

For example, authentication information may include information that enables the AI/ML AF (or any associated AI/ML applications servers) and/or the UE (or the AI/ML Application client on the UE) to verify the authenticity the AI/ML traffic exchanged.

For example, mode of reporting may include either direct reporting over 3GPP or indirect reporting via non-3GPP.

### Sharing/Application of Transport Configuration Information

In certain examples, the AI/ML transport configuration information may be (pre)-configured, for example by the AI/ML Application Service Provider on the AI/ML AF and/or the AI/ML Application client on the UE. In certain examples, the AI/ML transport configuration information may be dynamically configured.

In certain examples, the UE may indicate the possibility and/or capability to receive the AI/ML transport configuration information (or an associated policy). For example, such indication may be made as part of protocol configuration options (PCO) during PDU Session establishment and/or PDU session modification procedures. The UE may receive at least part of AI/ML transport configuration information (or the associated policy) via any suitable entity, for example the SMF or AMF (e.g. over Non-Access-Stratum (NAS) messages and commands). This may be also shared as part of AI/ML UE policy or Route Selection Policy (URSP) from PCF.

To do so, the AI/ML Service Provider may use the AF requests to influence the traffic routing either directly (e.g. for AI/ML AF in trusted domain) or indirectly via NEF (e.g. for AI/ML AF in untrusted domain), for example as part of PDU session establishment and/or modification procedure to update AI/ML transport configuration information and/or associated validity parameters.

The AI/ML AF request may include as Traffic Description any suitable type of information, for example any combinations of one or more of DNN, S-NSSAI, Application Identifier, Application ID or traffic filtering information that addresses the AI/ML AF or any associated AI/ML applications server(s). If the request is via NEF, the AF request may use an (external) AF service Identifier as Traffic Description and then NEF may translate that to any combination of one or more of DNN, S-NSSAI, Application Identifier, Application ID or traffic filtering information.

In certain examples, the request may also include one or more other parameters, in addition to AI/ML transport configuration information. For example, the parameters may include one or more parameters for enabling the 5GC (e.g. UDR, PCF or SMF) to compile/generate the transport policy and associated validity parameters.

For example, the AF request may include one or more of the following:
Potential location information of AI/ML applications, for example that could be in form of DNAI(s) (e.g. for AI/ML AF in trusted domain).
Target UE Identifier(s), for example if transport configuration information is applicable to an individual UE (e.g. for AI/ML operation splitting or AI/ML model distribution), a group of UEs (e.g. for AL/ML model distribution or federated learning), or any UE (e.g. to support any types of AI/ML operation). Any suitable type of identifier(s) may be used. For example, for AI/ML AF in trusted domain, an identifier may include subscription permanent identifier(s) (SUPI(s)), internal UE identifier(s) and/or internal group ID(s). For AI/ML AF in untrusted domain, an identifier may include generic public subscription identifier(s) (GPSI(s)), external UE identifier(s) and/or external group ID(s) to be translated to SUPI(s), internal UE identifier(s) and/or internal group ID(s), for example by the NEF.
Spatial validity information, for example if there are any geographic boundaries for transport configuration information. Any suitable type of spatial validity information may be used. For example, for AI/ML AF in trusted domain, the information may include tracking area identity (TAI) or other suitable resolution of location data. For AI/ML AF in untrusted domain, the information may include geographic zones to be translated to TAI, or other resolutions of location data, for example by the NEF.
Time validity information, for example if there is any expiry time for transport configuration information.
User Plane Latency Requirements, for example if the AI/ML traffic type(s) are associated with certain latency requirements to support AI/ML operation.
Any other Service or Quality of Experience Requirements, for example if the AI/ML operation is associated with certain service requirement or quality of experience requirement.
Indication(s) associated with certain AI/ML traffic type(s), type of AI/ML operation or a unified AI/ML traffic.
   Example of AI/ML AF Influence Over Traffic Routing and/or Reconfiguration for AI/ML Traffic

In various examples of the present disclosure, transport configuration information may be shared/communicated between various network entities. Various network entities may store received transport configuration information and/or perform updates and/or (re) configuration according to received/stored transport configuration information.

The transport configuration information may comprise one or more items of information as disclosed above, and/or any other suitable information. The transport configuration information may be shared, for example using an AF request as disclosed above, or any other suitable technique. In certain examples, the architecture disclosed above, or any other suitable architecture, may be used to share the transport configuration information, and for transmitting any other message(s) for performing updating and/or (re) configuration according to transport configuration information.

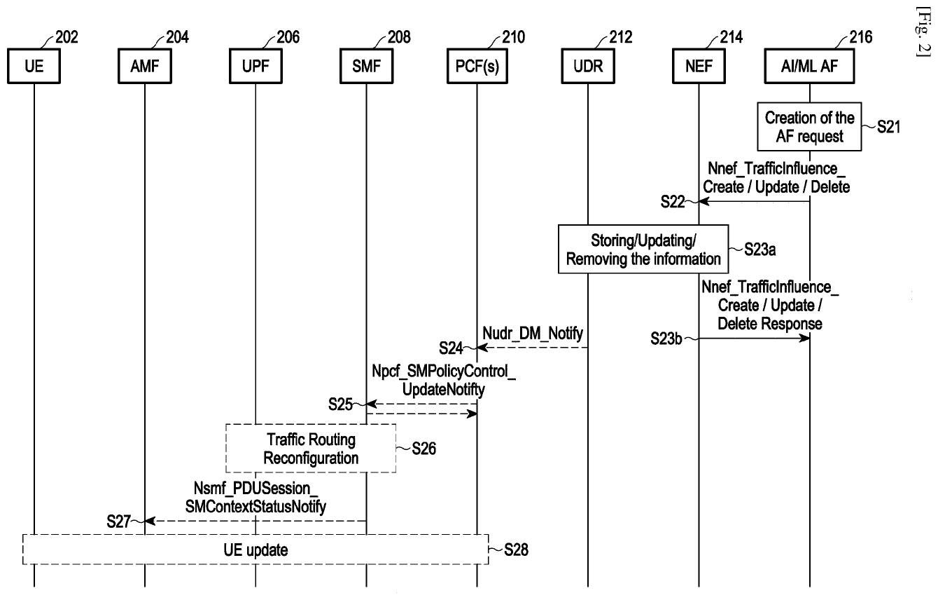

FIG. 2 shows a representation of a call flow according to an embodiment of the present invention. However, the skilled person will appreciate that the present disclosure is not limited to the example of FIG. 2. For example, transport configuration information may be shared/communicated between any suitable network entities. Furthermore, any suitable network entities may store received transport configuration information and/or perform updates and/or (re) configuration according to received/stored transport configuration information.

In operations S21 and S22, the AI/ML AF 216 (e.g., AI/ML AF 102) (or NEF 214 (e.g., NEF 120) may create, update (or delete from) the UDR 212 with the AI/ML transport configuration information and other related parameters (e.g. via UDM (unified data management) services).

In operation S23a, the UDR 212 may store or update the new AI/ML transport configuration information and other related parameters (or remove old transport configuration information, if any). In operation 23b, the NEF 214 may respond to the message (e.g., create, update, or delete) of operation S22.

In operation S24, the UDR 212 may notify the PCF 210. This operation may be based on an earlier subscription of the PCF(s) 210 to modifications of AF requests. For example, any combinations of one or more of DNN, S-NSSAI, AI/ML application identifier, SUPI, or internal group identifier may be used as the data key to address the PCF 210.

In operation S25, the PCF 210 may determine if the AI/ML PDU sessions or transport policy are impacted and may update SM polices and may notify the SMF 208 based on SM Policy Control Update.

In operation S26, the SMF 208 may take appropriate action(s) to reconfigure the User plane of the PDU Session(s) transporting the AI/ML traffic(s). Non-limiting examples of such action(s) include one or more of the following: Allocate a new Prefix to the UE 202 (e.g., UE 104);
Update the UPF 206 (e.g. in a target DNAI) with new traffic steering rules; and/or
Determine whether to relocate the UPF 206 (e.g. in coordination with AI/ML AS) considering requirements provided by the AI/ML AF 216, for example on location information, target UE IDs, spatial validity, time validity, UP latency and/or service requirements, and/or any other suitable indication associated with the AI/ML operation.

In operation S27, the SMF 208 may send the target DNAI to the AMF 204 for triggering SMF/I-SMF (re) selection and then inform the target DNAI information for the current PDU session or for the next PDU session to AMF 204, for example via Nsmf_PDUSession_SMContextStatusNotify service operation.

In operation S28, the SMF 208 may also update the UE 202 on the new or revised AI/ML transport policy (e.g. over non-access-stratum (NAS) messages) together with other session management (SM) subscription information. Non-limiting examples include one or more of the following:
Update AI/ML AF address;
Update AI/ML DNS server address;
Update AI/ML metadata information;
Update AI/ML traffic type(s); and/or
Update AI/ML authentication information.

The skilled person will appreciate that the call flow of FIG. 2 is only an example and that various alternatives fall within the scope of the present disclosure.

For example, as an alternative procedure, the PCF (e.g., PCF 210) may use a user configuration update procedure to update UE AI/ML policy or the URSP on the UE for AI/ML transport policy (e.g. via AMF 204). If so, the traffic descriptor in the AI/ML policy or URSP may be interpreted as AI/ML transport policy. For example, Application descriptor may match AI/ML application OS Id and OSAPP Id on the UE. IP descriptors and domain descriptors (or non-IP descriptors) may match the AI/ML AF address. Connection capabilities may match AI/ML Traffic type(s). Route selection descriptor (RSD) may match session and service continuity (SSC), S-NSSAI, DNN, PDU session type, time window and location criteria set per AI/ML Traffic type or per unified traffic type. This may be based on AI/ML transport configuration information in step S21. In certain examples, access type preference and/or non-seamless offload indication (or a similar information element) may be used to indicate the usage of direct reporting via 3GPP (i.e. S12 reference point) versus indirect reporting via non-3GPP (i.e. combination of S17 and S13).

In the above examples, the AI/ML application client (e.g., direct AI/ML application client 110) on the UE side (e.g., UE 104) may deliver part of AI/ML transport configuration information to the AI/ML application 112 on the UE 104, for example based on S16 interface or based on another logic outside 3GPP scope.

In the above examples, the UE (e.g., UE 104) or the AI/ML application client (e.g., direct AI/ML application client 110)) on the UE 104 may correctly translate the FQDN(s) of the AI/ML AF (e.g., AI/ML AF 102) or any associated AI/ML applications server(s) (e.g., AI/ML AS 114) to the IP addresses of the AI/ML AF or any associated AI/ML applications server(s). This may be done, for example, by accessing a local, private or global DNS server. As disclosed above, the DNS server address or related configurations for the UE may also be optionally shared as part of transport configuration information if needed (e.g. for a private DNS).

In certain examples, the AI/ML AF (e.g., AI/ML A 102) (or NEF (e.g., NEF 120)) may find the PDU session(s) serving the SUPI, DNN, S-NSSAI from UDM and the allocated IPv4 address or IPv6 prefix or both from the SMF. The AI/ML AF (or NEF) may store the UE IP address or any other external UE IDs during the PDU session establishment to the UE (or AI/ML application client on the UE). The AI/ML AF (or NEF) may correlate and store a mapping of the UE IP address (or any other external UE ID) and the SUPI retrieved (e.g. via UDM/SMF), using the IPv4 address or IPv6 prefix allocated by the SMF.

The skilled person will appreciate that one or more of the operations of FIG. 2 may be optional in certain examples, for example operations indicated with dotted lines.

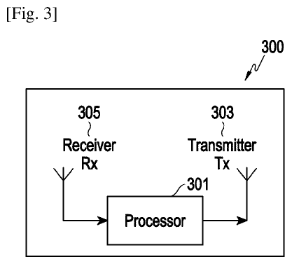

FIG. 3 is a block diagram of an exemplary network entity that may be used in examples of the present disclosure, such as the techniques disclosed in relation to FIG. 1 and/or FIG. 2. For example, the UE (e.g., UE 104 or UE 202), AI/ML AF (e.g., AI/ML AF 102 or AI/ML AF 216), NEF (e.g., NEF 120 or NEF 214), UDR (e.g., UDR 212), PCF(s) (e.g., PCF(s) 210), SMF (e.g., SMF 208), UPF (e.g., UPF 206), AMF (e.g., AMF 204) and/or other NFs may be provided in the form of the network entity illustrated in FIG. 3. The skilled person will appreciate that a network entity may be implemented, for example, as a network element on a dedicated hardware, as a software instance running on a dedicated hardware, and/or as a virtualised function instantiated on an appropriate platform, e.g. on a cloud infrastructure.

The entity 300 may comprise a processor (or controller) 301, a transmitter 303 and a receiver 305. The receiver 305 may be configured for receiving one or more messages from one or more other network entities by wire or wirelessly, for example as described above. The transmitter 303 may be configured for transmitting one or more messages to one or more other network entities by wire or wirelessly, for example as described above. The processor 301 may be configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention, as defined by the appended claims.

### Acronyms and Definitions

3GPP: 3rd Generation Partnership Project
5G: 5th Generation
5GC: 5G Core
5GS: 5G System
AF: Application Function
AI: Artificial Intelligence
AMF: Access and Mobility management Function
AS: Application Server
ASP: Application Service Provider
DCAF: Data Collection Application Function
DNAI: Data Network Access Identifier
DNN: Data Network Name
DNS: Domain Name Server
FQDN: Fully Qualified Domain Name
GPSI: Generic Public Subscription Identifier
ID: Identity/Identifier
IMEI: International Mobile Equipment Identities
IP: Internet Protocol
I-SMF: Intermediate SMF
ML: Machine Learning
MNO: Mobile Network Operator
MT: Mobile Termination
NAS: Non-Access Stratum
NEF: Network Exposure Function
NRF: Network Repository Function
NW: Network
NWDAF: Network Data Analytics Function
OS: Operating System
OSAPP: OS Application
PCF: Policy Control Function
PCO: Protocol Configuration Options
PDU: Protocol Data Unit
RSD: Route Selection Descriptor
SIM: Subscriber Identity Module
SLA: Service Level Agreement
SM: Session Management
SMF: Session Management Function
S-NSSAI: Single Network Slice Selection Assistance Information
SSC: Session and Service Continuity
SUPI: Subscription Permanent Identifier
TAI: Tracking Area Identity
TE: Terminal Equipment
TS: Technical Specification
UDM: Unified Data Manager
UDR: Unified Data Repository
UE: User Equipment
UL: Uplink
UP: User Plane
UPF: User Plane Function
URSP: UE Route Selection Policy

1. A method for configuring artificial intelligence/machine learning (AI/ML) traffic transport in a wireless communications network, the method comprising:
receiving, by a policy control function (PCF), from a unified data repository (UDR) that stores AI/ML transport configuration information, a notification of an update of the AI/ML transport configuration information;
determining, by the PCF, whether an AI/ML protocol data unit (PDU) session or a transport policy is impacted by the update; and
based on determining that the AI/ML PDU session or the transport policy being impacted by the update, notifying, by the PCF, a session management function (SMF) that a session management (SM) policy is updated,
wherein the SMF is configured to reconfigure the PDU session transporting AI/ML traffic based on the updated SM policy.

2. The method of claim 1, further comprising:
sending, by the SMF, to an access and mobility management function (AMF), information on the reconfigured PDU session.

3. The method of claim 1, further comprising:
updating, by the SMF, a user equipment (UE) based on the AI/ML transport configuration information.

4. The method of claim 3, further comprising indicating, by the UE, a capability for receiving the AI/ML transport configuration information during a PDU session establishment or PDU session modification procedure.

5. The method of claim 1, wherein the AI/ML transport configuration information is received by the UDR as part of an AI/ML application function (AF) request.

6. The method of claim 5, wherein the AI/ML AF request further includes a traffic description, the traffic description including one or more of a data network name (DNN), a single network slice selection assistance information (S-NSSAI), an application identifier, an application ID, or traffic filtering information.

7. The method of claim 5, wherein the AI/ML AF request further includes one or more of potential location information of AI/ML applications, target user equipment (UE) identifiers, spatial validity information, time validity information, user plane latency requirements, quality of experience requirements, or indications associated with a AI/ML traffic type.

8. The method of claim 1, wherein the PDU session transports AI/ML traffic, and reconfiguring the PDU session includes reconfiguring a user plane of the PDU session.

9. The method of claim 1, wherein the AI/ML transport configuration information is received by the UDR from an AI/ML application function (AF) or a network exposure function (NEF).

10. The method of claim 5, wherein the AI/ML transport configuration information is pre-configured by a AI/ML service provider on an AI/ML AF or an AI/ML application client on a user equipment (UE).

11. The method of claim 5, wherein the AI/ML transport configuration information includes one or more of an AI/ML AF address, an AI/ML domain name system (DNS) server address, an AI/ML traffic type, or AI/ML authentication information.

12. The method of claim 5, wherein the AI/ML transport configuration information is determined by a service level agreement (SLA) between a mobile network operator (MNO) and an AI/ML application service provider associated with an AI/ML AF.

13. The method of claim 1, wherein the AI/ML transport configuration information is per AI/ML application ID.

14. A policy control function (PCF) for configuring artificial intelligence/machine learning (AI/ML) traffic transport in a wireless communications network, the PCF comprising:
a transceiver; and
a processor coupled with the transceiver and configured to control the transceiver to:
receive, from a unified data repository (UDR) that stores AI/ML transport configuration information, a notification of an update of the AI/ML transport configuration information,
determine whether an AI/ML protocol data unit (PDU) session or a transport policy is impacted by the update, and
based on determining that the AI/ML PDU session or the transport policy being impacted by the update, notify a session management function (SMF) that a session management (SM) policy is updated,
wherein the SMF is configured to reconfigure the PDU session transporting AI/ML traffic based on the updated SM policy.

15. The PCF of claim 14, wherein the SMF is configured to send, to an access and mobility management function (AMF), information on the reconfigured PDU session.

16. The method of claim 3, wherein updating the UE based on the AI/ML transport configuration information comprises updating one or more of an AI/ML application function (AF) address, an AI/ML domain name system (DNS) server address, or AI/ML authentication information.

17. The method of claim 5, wherein the AI/ML AF request is received directly from an AI/ML AF or via a network exposure function (NEF).

18. The method of claim 17, wherein the AI/ML AF request is part of a PDU session establishment procedure or a PDU session modification procedure for updating the AI/ML transport configuration information or associated validity parameters.

19. The method of claim 8, wherein reconfiguring a user plane of the PDU session includes one or more of allocating a new prefix to a user equipment (UE), updating a user plane function (UPF) with new traffic steering rules, or determining whether to relocate the UPF.

20. The PCF of claim 15, wherein the SMF is configured to update a user equipment (UE) based on the AI/ML transport configuration information.
